(19) United States
(12) Patent Application Publication
(10) Pub. No.: US 2011/0296223 A1
(43) Pub. Date: Dec. 1, 2011

(54) Electronic Apparatus and Control Method of the Electronic Apparatus

(76) Inventors: Gen Watanabe, Akishima-shi (JP); Masayuki Sanada, Hamura-shi (JP)

(21) Appl. No.: 13/107,098

(22) Filed: May 13, 2011

(30) Foreign Application Priority Data
May 28, 2010 (JP) 2010-123223

(51) Int. Cl. G06F 1/32

(52) U.S. Cl. 713/324

(57) ABSTRACT

According to one embodiment, an electronic apparatus includes a display, an operating module, a power saving module, a sensor and a controller. The power saving module is configured to turn off a screen of the display when a non-operating period of the operating module reaches a reference period. The sensor is configured to detect a vibration. The controller is configured to change the reference period from a first value given as the initial value to a second value longer than the first value when the sensor detects a vibration.

### CROSS-REFERENCE TO RELATED APPLICATIONS

This application is based upon and claims the benefit of priority from Japanese Patent Application No. 2010-123223, filed May 28, 2010; the entire contents of which are incorporated herein by reference.

### FIELD

Embodiments described herein relate generally to a portable electronic apparatus, which is usable in a state of being held in the hand, and to a control method of the electronic apparatus.

### BACKGROUND

In recent years, various battery-powered electronic apparatuses such as notebook computers, personal digital assistants (PDAs) and smartphones have come into wide use. For example, these electronic apparatuses are easily usable during travel by train. In this kind of electronic apparatus, a mechanism for power saving has been variously proposed in order to maximize operating time by battery. For example, according to the foregoing power saving, the screen of a display device is automatically and diligently turned off under a predetermined condition such that a computer is not operated for a predetermined time.

For example, when the user operates a notebook computer on a desk, the screen of a display device is turned off if he does not operate a keyboard and a pointing device for a predetermined period. In this case, for example, the user presses an arbitrary key on the keyboard or contacts the pointing device, and thereby, the screen of the display device is returnable to an on state.

For example, the user operates a notebook computer while holding it in his hand, and in this state, browses material displayed on the screen of a display device. Namely, in such a case, the user is situated under the condition hard to operate a keyboard and a pointing device. In the foregoing state, when the screen of the display device is uniformly turned off resulting from the reason why the keyboard or the pointing device is not operated for a predetermined period, the user feels hard to use.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an electronic apparatus according to an embodiment.

FIG. 2 is an exemplary block diagram showing the system configuration of the electronic apparatus according to the embodiment.

FIG. 3 is an exemplary flowchart showing the procedure of operating the electronic apparatus according to the embodiment.

FIG. 4 is an exemplary flowchart showing one modification example of the procedure of operating the electronic apparatus according to the embodiment.

### DETAILED DESCRIPTION

Various embodiments will be described hereinafter with reference to the accompanying drawings.

In general, according to one embodiment, an electronic apparatus includes a display, an operating module, a power saving module, a sensor and a controller. The power saving module is configured to turn off a screen of the display when a non-operating period of the operating module reaches a reference period. The sensor is configured to detect a vibration. The controller is configured to change the reference period from a first value given as the initial value to a second value longer than the first value when the sensor detects a vibration.

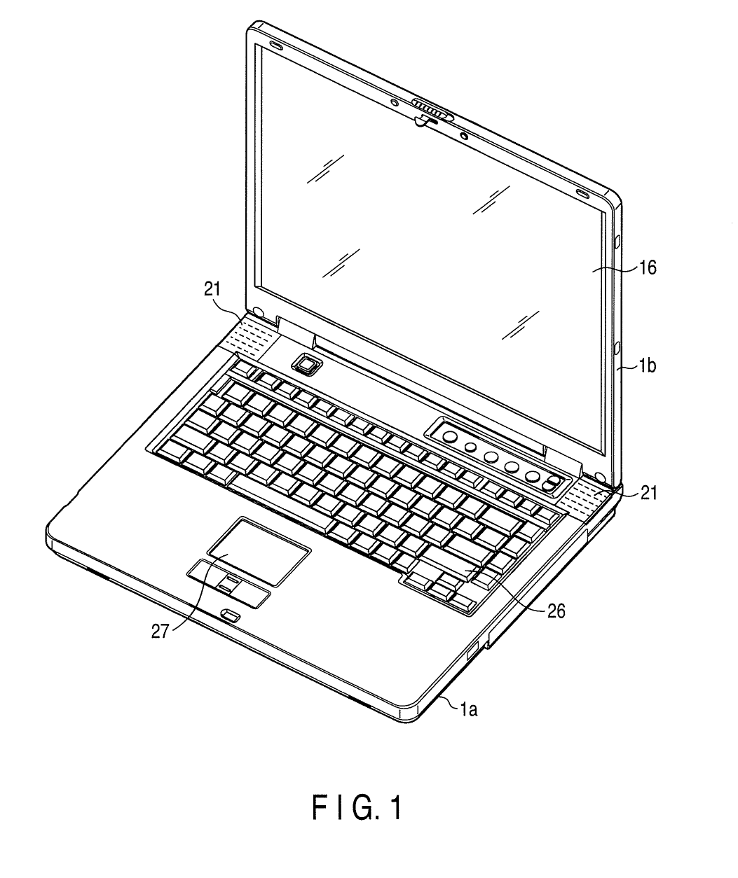

FIG. 1 is an exemplary perspective view showing the appearance of an electronic apparatus according to an embodiment. For example, an electronic apparatus of this embodiment is realized as an easily portable notebook computer. The electronic apparatus includes a main body 1a and a display unit 1b. The display unit 1b has a built-in display device formed of a liquid crystal display (LCD) 16.

The display unit 1b is attached to the main body 1a so that it is freely rotatable between the following positions. One is an open position in which the upper surface of the main body 1a is exposed. The other is a closed position in which the upper surface of the main body 1a is covered with the display unit 1b. The main body 1a has a thin box-shaped housing. The upper surface of the main body 1a is provided with a keyboard 26 and a pointing device 27.

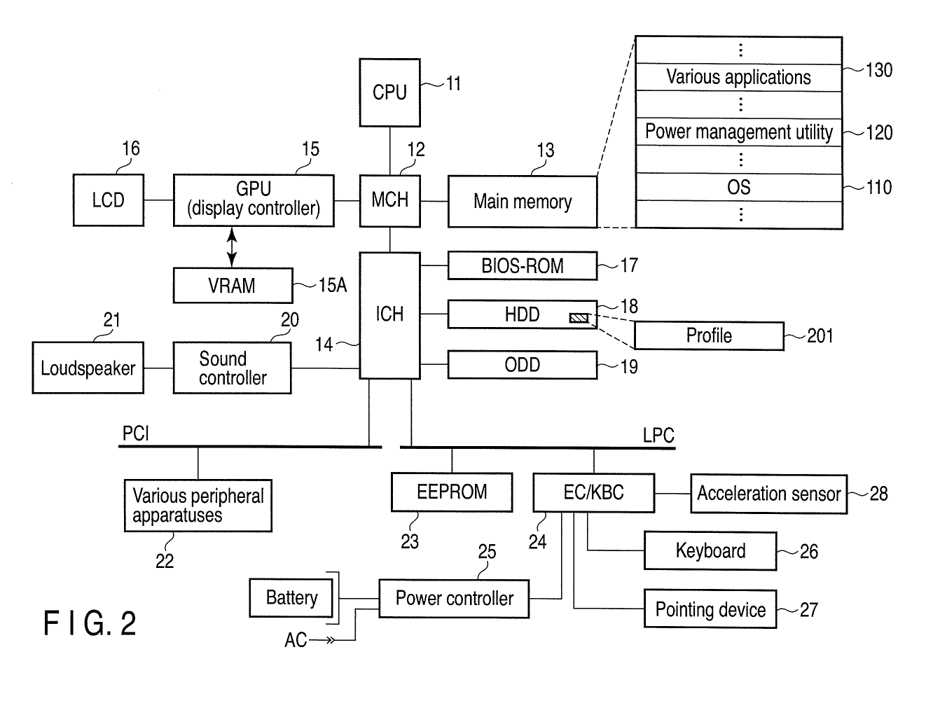

FIG. 2 is an exemplary block diagram showing the system configuration of an electronic apparatus according to the embodiment.

As shown in FIG. 2, the electronic apparatus includes a central processing unit (CPU) 11, a memory controller hub (MCH) 12, a main memory 13, an I/O controller hub (ICH) 14 and a graphics processing unit (GPU: display controller) 15. Further, the electronic apparatus includes a video memory (VRAM: video random access memory) 15A, a LCD 16, a Basic Input/Output System read-only memory (BIOS-ROM) 17, a hard disk drive (HDD) 18, an optical disc drive (ODD) 19 and a sound controller 20. Further, the electronic apparatus includes a Loudspeaker 21, various peripheral apparatuses 22, an electrically erasable programmable ROM (EEPROM) 23, an embedded controller/keyboard controller (EC/KBC) 24, a power controller 25, a keyboard 26, a pointing device 27 and an acceleration sensor 28.

The CPU 11 is a processor, which controls the operation of the electronic apparatus. The CPU 11 executes various programs loaded from HDD 18 and ODD 20 to the main memory 13. The foregoing various programs executed by the CPU 11 includes an operating system (OS) 110, which controls resource management, a power management utility 120 described later, which is operated under the control of the OS 110, and various application programs 130. Moreover, the CPU 11 executes a BIOS stored in the BIOS-ROM 17. The BIOS is a program for hardware control.

The MCH 12 operates as a bridge, which making a connection between CPU 11 and ICH 14, and further, operates as a memory controller, which controls an access to the main memory 13. Moreover, the MCH 12 includes a function of performing a communication with the GPU 15.

The GPU 15 is a display controller, which controls the LCD 16 incorporated into the electronic apparatus. The GPU 15 includes a VRAM 15A, and further, includes a built-in accelerator, which draws an image displayed by various programs in place of the CPU 11.

The ICH 14 includes a built-in Integrated Device Electronics (IDE) controller for controlling the foregoing HDD 18 and ODD 19. Further, the ICH 14 controls various peripheral apparatuses 22 connected to a Peripheral Component Interconnect (PCI) bus. Moreover, the ICH 14 includes a communication function with the sound controller 20. The sound controller 20 is a sound source device. The sound controller 20 outputs audio data, which are provided as a reproduction target by various programs, to the speaker 21 built in the electronic apparatus.

The EEPROM 23 is a memory device for storing individual computer information of the electronic apparatus, for example. The EC/KBC 24 is a one-chip micro processing unit (MPU), which is integrated with an embedded controller and a keyboard controller. The embedded controller is used for performing power management in association with the power controller 25. The keyboard controller is used for controlling data input by operating the keyboard 26 and the pointing device 27.

The foregoing EC/KBC 24 is connected with an acceleration sensor 28. The acceleration sensor 28 is a sensor for detecting a vibration. For example, the acceleration sensor 28 is used for realizing a protective function of retracting a head of the HDD 18 if the sensor 28 senses a vibration. The electronic apparatus utilizes the foregoing acceleration sensor 28 to realize the control, which takes a balance of power saving and improvement of availability into consideration. Hereinafter, the foregoing control will be detailedly described.

The power management utility 120, which is operated on the electronic apparatus having the foregoing system configuration, is a program for providing a power saving function of turning off a screen of the LCD 16 in the following cases, for example. One is the case where the display unit is closed in a state that the screen of the LCD 16 is turning on. The other is the case where the keyboard 26 or the pointing device 27 is not operated beyond a predetermined period.

The power management utility 120 stores a profile 201 in the HDD 18. The profile 201 holds a reference value indicating a period until the screen of the LCD 16 is turned off after the operation of the keyboard 26 or the pointing device 27 is stopped. Further, the utility 120 monitors a generation of interruption generated by the EC/KBC 24 when the keyboard 26 or the pointing device 27 is operated. In this way, the utility 120 senses whether or not the keyboard 26 or the pointing device 27 is operated. Moreover, the EC/KBC 24 generates an interruption resulting from the fact that the acceleration sensor 28 senses a vibration more than a reference. Therefore, the power management utility 120 monitors the generation of the foregoing interruption, and thereby, can sense a vibration.

Now, the foregoing profile 201 holds a reference value such as three minutes. Namely, basically, in the electronic apparatus, the screen of the LCD 16 is turned off by the power management utility 120 if the keyboard 26 or the pointing device 27 is not operated beyond three minutes. The foregoing value such as three minutes is the initial value, which is applied when the power of the electronic apparatus is turned on.

For example, the user uses this electronic apparatus in a state of holding it in his hand during travel by train. When the user holds the electronic apparatus in his hand, the electronic apparatus is vibrated by shaking of the arm. Thus, the electronic apparatus determines manual operation by the user by recognizing the following states; namely, the screen of the LCD is in a state of being turned on and a vibration is detected by the acceleration sensor 28.

Under the foregoing conditions, for example, the power management utility 120 changes a reference value such as three minutes held in the profile 201 to 30 minutes if a vibration is detected by the acceleration sensor 28. Namely, if the user uses this electronic apparatus in a state of being set on a desk, the screen of the LCD 16 is turned off when the keyboard 26 or the pointing device 27 is not operated beyond three minutes. On the other hand, the foregoing reference value is set to a long period such as 30 minutes.

In this way, even if the user uses the electronic apparatus in a state of holding this in his hand (hard to operate the keyboard 26 or the pointing device 27), this serves to prevent the user from feeling inconvenient in operability. For example, if the reference value after changed is set to infinity, the screen of the LCD 16 is not turned off while the user uses the electronic apparatus in a state of holding it in his hand.

There is provided a mechanism of changing the reference value held in the profile 201 in accordance with the event whether or not a vibration is detected by the acceleration sensor 28. This serves to obtain the following advantage. For example, if the user uses the electronic apparatus in a state of being set on a desk, a balance with power saving is taken because the screen of the LCD 16 is turned off when the keyboard or the pointing device 27 is not operated more than three minutes.

The power management utility 120 resets the reference value held in the profile 201 to the initial value, that is, three minutes in the following cases. One is the case where detection of vibration by the acceleration sensor 28 is stopped beyond a predetermined period. The other is the case where the screen of the LCD 16 is turned off when the keyboard or the pointing device is not operated for a predetermined period (i.e., time shown by reference value).

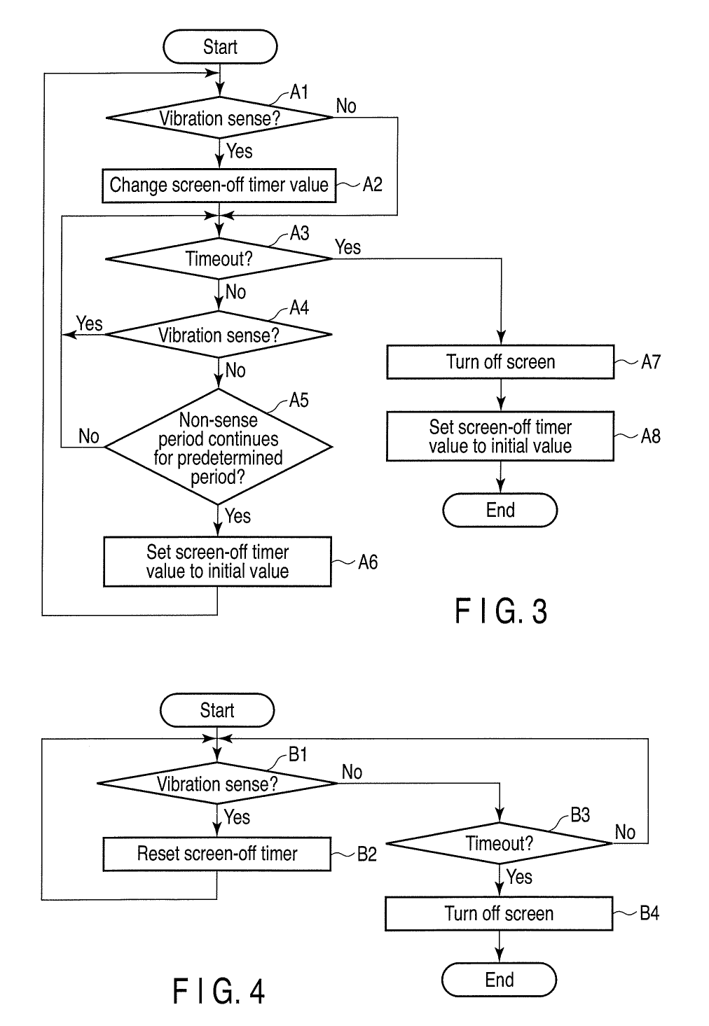

FIG. 3 is an exemplary flowchart showing the operating procedure related to a screen turn-off control of the electronic apparatus according to the embodiment. In the start of the flowchart shown in FIG. 3, the electronic apparatus is in a state that a screen of the LCD 16 is turned on.

In a state that the screen of the LCD 16 is turned on, when the acceleration sensor 28 senses a vibration (block A1), the power management utility 120 executes the following procedure. Namely, the utility 120 changes a reference value held in the profile 201 showing a period until the screen of the LCD 16 is turned off after the operation of the keyboard 26 or the pointing device 27 is stopped (block A2).

The power management utility 120 monitors whether or not the keyboard 26 or the pointing device 27 is not operated within the period shown by the reference value held in the profile 201 (whether or not timeout occurs) (block A3). In addition, until the foregoing timeout occurs, the utility 120 monitors whether or not the acceleration sensor 28 does not sense a vibration beyond a predetermined period (block A4, block A5). If the acceleration sensor 28 does not sense a vibration beyond a predetermined period (YES in block A5), the utility 120 resets the reference value held in the profile 201 to the initial value (block A6).

If the foregoing timeout occurs (YES in block A3), the power management utility 120 turns off the screen of the LCD 16 (block A7). Then, the utility 120 resets the reference value held in the profile 201 to the initial value (block A8).

As can be seen from the foregoing description, the electronic apparatus does not use a fixed reference value, but based on the detection result of the acceleration sensor 28, the reference value held in the profile 201 is adaptively changed. In this way, it is possible to realize the screen-off control of the LCD, which takes a balance of power saving with improvement of availability.

As described above, when the acceleration sensor 28 detects a vibration, the reference value is changed to infinity. In this way, the screen of the LCD 16 is not turned off while the user uses the electronic apparatus in a state of holding it in his hand. One modification example of the operating procedure in which “the screen of the LCD 16 is not turned off while the user uses the electronic apparatus in a state of holding it” will be described below with reference to a flowchart shown in FIG. 4.

A power management utility 120 monitors whether or not the keyboard 26 or the pointing device 27 is not operated within a period shown by a reference value held in a profile 201 (i.e., whether or not timeout occurs). Then, when the acceleration sensor 28 detects a vibration (block B1), the power management utility 120 resets a timer used for the foregoing monitoring (block B2). If the electronic apparatus is used in a state of being held in the user's hand, the acceleration sensor 28 continues to detect a vibration; therefore, timeout does not occur. Namely, the screen of the LCD 16 is not turned off while the electronic apparatus is used in a state of being held in the user's hand.

On the other hand, for example, the electronic apparatus is used in a state of being set on a desk. In this case, under the condition that the acceleration sensor 28 does not detect a vibration (NO in block B1), when the operation of the keyboard 26 or the pointing device 27 is not operated within a period shown by a reference value held in a profile 201, timeout occurs (YES in block B3). Thus, the power management utility 120 turns off the screen of the LCD 16 (block B4).

According to the foregoing procedure, it is possible to realize the screen-off control of the LCD 16, which takes a balance of power saving with improvement of availability into consideration.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display;
an operating module;
a power saving module configured to turn off a screen of the display when a non-operating period of the operating module reaches a reference period;
a sensor configured to detect a vibration; and
a controller configured to change the reference period from a first value given as the initial value to a second value longer than the first value when the sensor detects a vibration.

2. The apparatus of claim 1, wherein the controller is configured to return the reference period to the first value when a non-detection period by the sensor reaches a predetermined period after the controller changes the reference period to the second value.

3. The apparatus of claim 1, wherein the controller is configured to return the reference period to the first value when the screen of the display is turned off by the power saving module.

4. The apparatus of claim 1, wherein the sensor comprises an acceleration sensor.

5. The apparatus of claim 1, wherein the second value comprises infinity.

6. An electronic apparatus comprising:
a display;
an operating module;
a power saving module configured to turn off a screen of the display when a non-operating period of the operating module reaches a reference period;
a sensor configured to detect a vibration; and
a controller configured to reset a timer for counting a non-operation period of the operating module by the power saving module when the sensor detects a vibration.

7. The apparatus of claim 6, wherein the sensor comprises an acceleration sensor.

8. A control method of an electronic apparatus comprising a power saving function of turning off a screen of a display when a non-operating period reaches a reference period, the method comprising:
detecting a vibration; and
changing the reference period from a first value given as the initial value to a second value longer than the first value when a vibration is detected.

9. The method of claim 8, further comprising returning the reference period to the first value when a non-detection period of a vibration reaches a predetermined period after changing the reference period to the second value.

10. The method of claim 8, further comprising returning the reference period to the first value when the screen of the display is turned off by the power saving function.

11. The method of claim 8, wherein the second value comprises infinity.
